(19) United States
(12) Patent Application Publication
(10) Pub. No.: US 2022/0030342 A1
(43) Pub. Date: Jan. 27, 2022

(54) INTRINSICALLY-SAFE MICROPHONE ASSEMBLY

(71) Applicant: Knowles Electronics, LLC, Itasca, IL (US)

(72) Inventors: Charles King, Oak Park, IL (US); Daryl Barry, Wilmette, IL (US)

(21) Appl. No.: 17/312,055

(22) PCT Filed: Dec. 24, 2019
(86) PCT No.: PCT/US2019/068504

§ 371 Date: Jun. 9, 2021

Related U.S. Application Data
(60) Provisional application No. 62/799,723, filed on Jan. 31, 2019.

(51) Int. Cl. H04R 1/04

(52) U.S. Cl. CPC H04R 1/04; H04R 2201/003

(57) ABSTRACT

A microphone assembly includes a housing having a host device interface, a MEMS transducer disposed in the housing and configured to generate electrical signals in response to acoustic activity, an integrated circuit disposed in the housing and configured to process the electrical signals from the MEMS transducer and generate an output representative of the acoustic activity, a host communication path between the integrated circuit and contacts of the host device interface, and a secure communication path between the integrated circuit and an output interface. The secure communication path is isolated from the host communication path. The integrated circuit is configured to indicate a state of the microphone assembly at the output interface via the secure communication path in response to a command received at the microphone assembly.

### CROSS-REFERENCE TO RELATED APPLICATIONS

This application claims the benefit of and priority to U.S. Provisional Patent Application No. 62/799,723, filed Jan. 31, 2019, the entire contents of which are incorporated herein by reference.

### BACKGROUND

The present disclosure relates generally to microphones. More specifically, the present disclosure relates to techniques for providing improved security for microphone devices.

A user of a host device may have privacy concerns relating to data collected by the host device and what is done with that data. For example, an increasing number of smart devices operate in a normal state in which they are listening for an activation command in order to take actions by voice. While such devices provide a convenient and powerful way of interacting with the user, the user may have a desire to know what state the microphone is in to ensure it is not collecting/transmitting data when the user does not desire for it to do so.

### SUMMARY

One implementation of the present disclosure is a microphone assembly. The microphone assembly includes a housing having a host device interface, a MEMS transducer disposed in the housing and configured to generate electrical signals in response to acoustic activity, an integrated circuit disposed in the housing and configured to process the electrical signals from the MEMS transducer and generate an output representative of the acoustic activity, a host communication path between the integrated circuit and contacts of the host device interface, and a secure communication path between the integrated circuit and an output interface. The secure communication path is isolated from the host communication path. The integrated circuit is configured to indicate a state of the microphone assembly at the output interface via the secure communication path in response to a command received at the microphone assembly.

Another implementation of the present disclosure is a microphone assembly. The microphone assembly includes a housing having a host device interface, a MEMS acoustic transducer disposed in the housing and configured to generate electrical signals in response to acoustic activity, an integrated circuit disposed in the housing and configured to process the electrical signals from the acoustic transducer and generate an output representative of the acoustic activity, a host communication path between the integrated circuit and contacts of the host device interface, and a secure communication path between the integrated circuit and an input interface. The secure communication path is isolated from the host communication path. The integrated circuit is configured to change the state of the microphone assembly via the secure communication path in response to a command received at the input interface.

Another implementation of the present disclosure is a microphone assembly. The microphone assembly includes an acoustic transducer configured to generate electrical signals in response to acoustic activity, and an integrated circuit configured to process the electrical signals from the acoustic transducer and provide an output of the acoustic activity to host circuitry via a host communication path, detect a keyword in the electrical signals from the acoustic transducer, determine that the keyword corresponds to a predetermined keyword, in response to determining that the keyword corresponds to a predetermined keyword, change or verify a state of the microphone assembly via a secure path and in accordance with a command associated with the predetermined keyword. The secure path is isolated from the host communication path.

Another implementation of the present disclosure is an integrated circuit for a microphone assembly. The integrated circuit includes a first set of one or more contacts, a second set of one or more contacts, a third set of one or more contacts, and processing circuitry. The processing circuitry is configured to receive, from the first set of contacts, electrical signals from a microelectromechanical systems (MEMS) transducer, process the electrical signals from the MEMS transducer and generate an output representative of acoustic activity sensed by the MEMS transducer, communicate with a host device via the second set of contacts, and transmit, via the third set of contacts, an indication of a state of the microphone assembly to an output interface in response to a command received at the microphone assembly.

Another implementation of the present disclosure is a method in a microphone assembly comprising a MEMS transducer and an integrated circuit disposed in a housing having host device interface. The integrated circuit is coupled to contacts of the host device interface by a host communication path. The method includes generating electrical signals in response to acoustic activity with the MEMS acoustic transducer, generating an output representative of the acoustic activity by processing the electrical signals with the integrated circuit, and receiving a command at an input interface of the microphone assembly. The input interface is coupled to the integrated circuit by a secure communication path isolated from the host communication path. The method also includes indicating a state of the microphone assembly at an output interface via the secure communication path in response to receiving the command.

Another implementation of the present disclosure is a method in a microphone assembly comprising a MEMS transducer and an integrated circuit disposed in a housing having host device interface. The integrated circuit is coupled to contacts of the host device interface by a host communication path. The method includes generating electrical signals in response to acoustic activity with the MEMS acoustic transducer, generating an output representative of the acoustic activity by processing the electrical signals with the integrated circuit, and receiving a command at an input interface of the microphone assembly. The input interface is coupled to the integrated circuit by a secure communication path isolated from the host communication path. The method includes changing a state of the microphone assembly via the secure communication path in response to receiving the command.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a block diagram of a traditional host device.

FIG. 2 is a block diagram of a host device with an intrinsically safe microphone assembly, according to an exemplary embodiment.

FIG. 3 is a circuit diagram of a traditional microphone assembly.

FIG. 4 is a circuit diagram of a first exemplary embodiment of the intrinsically safe microphone assembly of FIG. 2.

FIG. 5 is a circuit diagram of a second exemplary embodiment of the intrinsically safe microphone assembly of FIG. 2.

FIG. 6 is a circuit diagram of a third exemplary embodiment of the intrinsically safe microphone assembly of FIG. 2.

FIG. 7 is a circuit diagram of a fourth exemplary embodiment of the intrinsically safe microphone assembly of FIG. 2.

FIG. 8 is a circuit diagram of a fifth exemplary embodiment of the intrinsically safe microphone assembly of FIG. 2.

FIG. 9A is an illustration depicting a first approach for ensuring a state of a microphone assembly, according to an exemplary embodiment.

FIG. 9B is an illustration depicting a second approach for ensuring a state of a microphone assembly, according to an exemplary embodiment.

FIG. 9C is an illustration depicting a third approach for ensuring a state of a microphone assembly, according to an exemplary embodiment.

FIG. 10 is a flowchart of a process for ensuring the state of a microphone assembly, according to an exemplary embodiment.

FIG. 11 is an illustration of the host device of FIG. 2, according to an exemplary embodiment.

FIG. 12 is an illustration of a button for use as an input to the microphone assembly of FIG. 2, according to an exemplary embodiment.

FIG. 13 is a circuit diagram of a sixth exemplary embodiment of the intrinsically safe microphone assembly of FIG. 2.

FIG. 14 is a cross-sectional view of the microphone assembly of FIG. 2, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods relating to microphone assemblies are shown. Microphones are often included with a host device such as a smartphone, tablet, laptop computer, smart speaker, or other electronic device. Microphones in host devices must be re-flowable, able to be used over large temperature ranges, survive dropping, and be small enough to fit within increasingly smaller devices. In many cases, a user of a host device may be concerned that the microphone of the host device could be receiving and recording acoustic activity (e.g., sounds made by the user) and could be providing the recorded acoustic activity to host circuitry of the host device. Furthermore, the host circuitry could be hacked or otherwise manipulated to provide the acoustic activity information to a third party via a network (e.g.., over the Internet). Because a touchscreen or other input/output device of a host device could be manipulated or controlled via hacking of the host circuitry of the host device, information relating to a current state of the microphone displayed by the host device may be unreliable in the event the host device has been hacked. In such a case, the user may have no reliable way of determining or controlling the current state of the microphone (e.g., as muted/unmuted, data-streaming/non-data-streaming, etc.). Accordingly, systems and methods for ensuring a current state of a microphone on a host device and communicating the current state to a user may be desirable. According to various implementations of the present disclosure, systems and methods are provided that help reduce the risk presented by host device hacking by providing direct input and/or output paths into the microphone that are isolated from the electrical paths utilized by the host device and, therefore, protected against hacking of the host device circuitry.

As used herein, “isolated” means that a first path is non-communicable with a second path (e.g., electrically isolated from the second path), such that communications (e.g., electrical signals) cannot be exchanged between the first path and the second path. In some cases, a first path may be “isolated” from a second path while sharing a power source and/or ground with the second path.

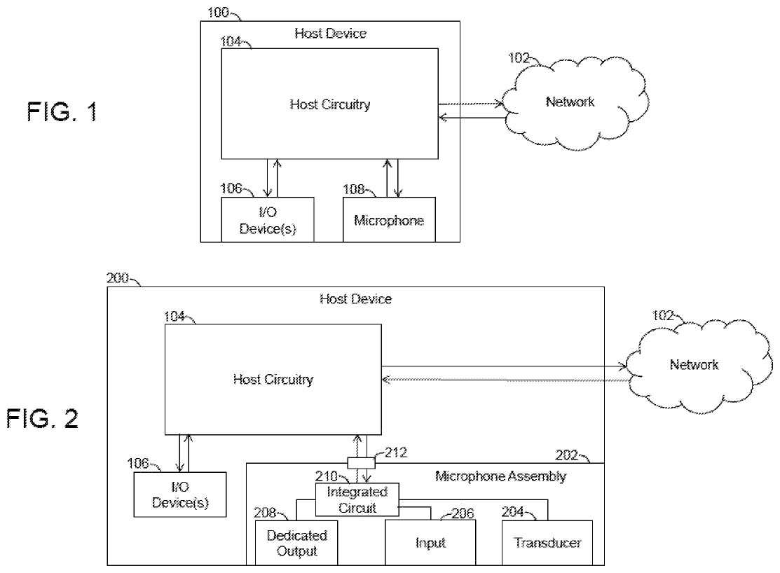

Referring now to FIG. 1, a block diagram of traditional host device 100 communicably coupled to a network 102 is shown, according to an exemplary embodiment. In various embodiments, the host device 100 is a smartphone, tablet, laptop computer, desktop computer, portable gaming device, or other personal computing device. In other embodiments, the host device 100 is a smart-speaker, communications portal, refrigerator, thermostat, or other internet-of-things device. In the examples shown herein, the host device 100 is a smartphone. The network 102 may include a wired or wireless network, including but not limited to one or more of a cellular network, a Bluetooth network, a Wi-Fi network, an intranet, or the Internet.

The host device 100 is shown to include host circuitry 104, I/O device(s) 106, and a microphone 108. The host circuitry 104 includes hardware components operable to provide the functionality of the host device 100. For example, the host circuitry 104 may include a central processing unit configured to execute various programs and applications of the host device 100. As another example, the host circuitry 104 may include network interface components configured to facilitate communication between the host circuit 104 and the network 102. The host circuitry 104 includes components that may be reprogrammed, controlled, copied, modified, or otherwise accessed over the network 102.

The I/O device(s) 106 are configured to output information to a user of the host device 100 and/or receive information from the user. The I/O device(s) 106 may include a display screen, a touchscreen, a speaker, an indicator light, buzzers, vibrators, switches, buttons, or any other hardware component capable of conveying information to a user and/or receiving information from the user. The I/O device(s) 106 are controllable by the host circuitry 104 and provide any user input to the host circuitry 104.

The microphone 108 is configured to receive acoustic signals from a surrounding environment, transform the acoustic signals into electronic signals, and provide the electronic signals to the host circuitry 104. At various times, the host circuit 104 may store the electronic signals, process the electronic signals (e.g., digital signal processing, speech recognition), and/or transmit the electronic signals to the network 102 (i.e., to a separate computing system communicable with the network 102).

Notably, the host circuitry 104 may be susceptible to hacking (e.g., illicitly or covertly accessed, reprogrammed, and/or modified) via the network 102 and/or via direct manipulation of the host circuitry 104. For example, the host circuitry 104 may be reprogrammed to cause data collected by the microphone 108 to be recorded, shared, and otherwise used in ways undesirable and unknown to a user of the host device or to a manufacturer or service provider of the host device 100. For example, the host circuitry 104 may be reprogrammed to upload data collected by the microphone 108 to a third party computing system (e.g., a hacker's computer, a state-sponsored surveillance system) via the network 102.

Furthermore, as shown in FIG. 1, any conductive path between the microphone 108 and the I/O device(s) 106 passes through the host circuitry 104. In one example, the host circuitry 104 controls the I/O device(s) 106 to display or otherwise provide (e.g., via audio output of a speaker) a state of the microphone 108 to a user, for example to indicate that the microphone 108 is muted or unmuted. However, in a case where the host circuit 104 has been hacked, the host circuitry 104 may be reprogrammed to cause the I/O device(s) 106 to present a false (deceitful) indication of the state of the microphone. For example, the I/O device(s) 106 may show that the microphone 108 is muted when the host circuitry 104 is in fact actively collecting data from the microphone 108 and transmitting that data to a third party computing system via the network 102.

Due to this vulnerability of the host device 100 of FIG. 1, a user of the host device 100 may experience a lack of confidence in the security of the host device 100 and, in particular, in the privacy of conversations held in proximity to the host device 100. The risk that data from the microphone 108 may be accessible to unknown third parties may be particularly problematic for users in high-profile or high-security roles or settings (e.g., politicians, military personnel, intelligence agencies, government contractors). Additionally, many consumers are becoming more concerned about privacy and may desire increased confidence in the security of the host device 100.

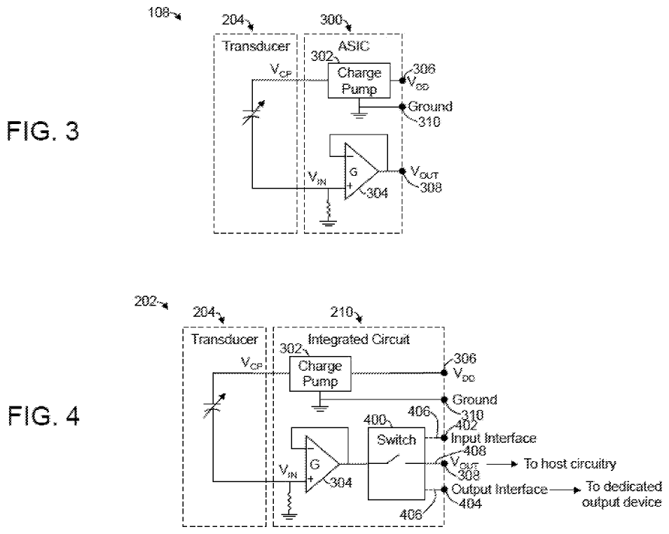

According to various implementations of the present disclosure, systems and methods are provided that help reduce the risk host device hacking presents by providing direct input and/or output paths into the microphone that are isolated from the electrical paths utilized by the host device and, therefore, protected against hacking of the host device circuitry. Referring now to FIG. 2, a host device 200 is shown communicably coupled to the network 102, according to an exemplary embodiment. The host device 200 includes the host circuitry 104 and one or more I/O devices 106 of the host device 100 of FIG. 1. As shown in FIG. 2, the host device 200 also includes a microphone assembly 202 configured to ensure a current state of the microphone assembly 202. The microphone assembly 202 is electrically coupled to the host circuitry 104.

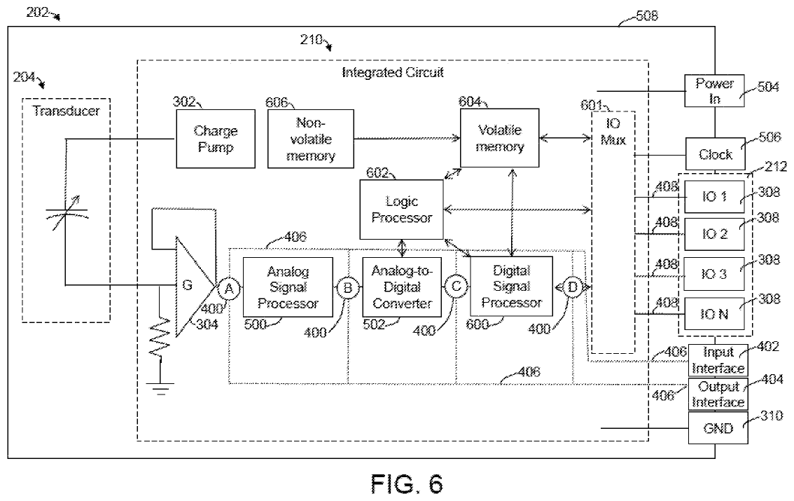

As shown in FIG. 2, the microphone assembly 202 includes a transducer 204, an input 206, a dedicated output 208, an integrated circuit 210, and host device interface 212. The host device interface 212 facilitates communication between the microphone assembly 202 and the host circuitry 104, and, in the embodiment shown, provides the only pathway for communication between the host circuitry 104 and the integrated circuit 210. Various embodiments of the microphone assembly 202 may include additional components, for example as shown in FIGS. 4-8 and described in detail with reference thereto.

The microphone assembly 202 may have various “states.” As used herein, a “state” of the microphone assembly 202 refers to an operating status of the microphone assembly, for example a data-streaming state in which the microphone assembly 202 provides data to the host circuitry or a non-data-streaming state in which the microphone assembly 202 is prevented from providing data to the host circuitry 204. Various other states are possible, including a muted state, an unmuted state, a programmable state, and a non-programmable state, an encrypted signal state, a non-encrypted signal state, for example as described in detail below.

The transducer 204 may be an acoustic transducer and, in some embodiments, is a microelectromechanical systems (MEMS) transducer. MEMS transducers and associated IC circuits can be designed to fit into small host devices.

For example, the transducer 204 may be a MEMS acoustic transducer including a diaphragm and a backplate spaced apart from one another to form a capacitor. The diaphragm moves in response to changes in pressure, such as due to acoustic activity incident on the MEMS transducer. The integrated circuit 210 senses the changes in capacitance and generates an output electrical signal representative of the sensed acoustic activity. While some embodiments of the present disclosure may include a MEMS transducer, it should be understood that the features of the present disclosure can be applied to any type of microphone device.

In another example, the transducer 204 may be a piezo-electric MEMS acoustic transducer including a diaphragm comprising a piezo electric element. The diaphragm moves in response to changes in pressure, such as due to acoustic activity incident on the MEMS transducer. The change in strain produces an electric field. The integrated circuit 210 senses the changes in electric field and generates an output electrical signal representative of the sensed acoustic activity. While some embodiments of the present disclosure may include a MEMS transducer, it should be understood that the features of the present disclosure can be applied to any type of microphone device.

The input 206 is configured to receive a command to provide and/or change a state of the microphone assembly and provide the command to the integrated circuit 210 via a secure path. The secure path is isolated from a host communication path, which provides for communication between the integrated circuit 210 and the host device interface 212. The secure path is therefore isolated from the host circuitry 104, such that the input 206 is also isolated from the host circuitry 104.

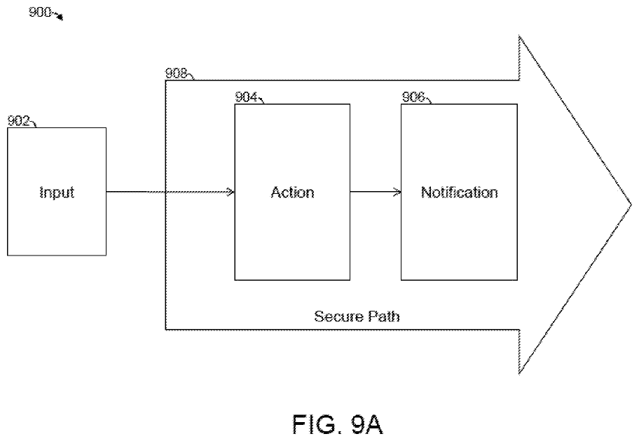

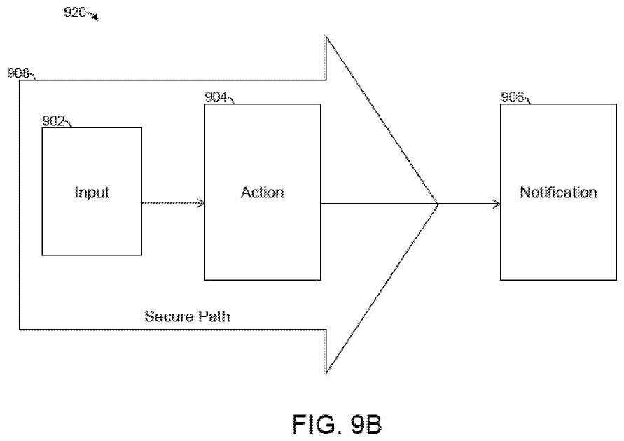

Various types of inputs 206 are possible. In some embodiments, the input 206 is a button, switch, or other user-manipulable mechanism configured to allow a user to provide the command to the input 206 by physically engaging the input 206. In some embodiments, the input 206 is an electrical interface configured to receive a signal from the transducer 204 or from a digital signal processor or logic processor that receives signals from the transducer 204, for example as shown in FIGS. 7-8 and described in detail with reference thereto. These and other examples are described in detail below.

The integrated circuit 210 is configured to process electrical signals from the transducer 204, generate an output indicative of the acoustic activity, and provide the output to the host circuitry 104 via the host communication path. In some implementations, the integrated circuit 210 may be or include an application specific integrated circuit (ASIC). The integrated circuit 210 is configured to receive the command to verify and/or change the state of the microphone assembly 202 from the input 206 via the secure path, determine and/or change the state of the microphone assembly 202 in accordance with the command, and transmit an indication of the state of the microphone assembly 202 to the output 208 via the secure path. For example, as described in detail below with reference to FIGS. 4-8, the integrated circuit 210 may change the state of the microphone assembly 202 by opening or closing one or more switches of the integrated circuit 210 in response to receiving the command.

The dedicated output 208 is configured to receive the indication of the state of the microphone assembly from the integrated circuit 210 and provide an indication of the state of the microphone assembly 202 to a user. The dedicated output 208 is separate from I/O device(s) 106 of the host device 200 (e.g., isolated from the I/O device(s) 106, clearly distinguishable by a user from the I/O device(s) 106). The dedicated output 208 is electrically communicable with the integrated circuit 210 via the secure path. Accordingly, the dedicated output 208 is isolated from the host circuitry 104. The dedicated output 208 is controlled by the integrated circuit 210.

In some embodiments, the dedicated output 208 includes an indicator light. The indicator light may illuminate, blink, turn off, etc. to provide the indication of the state of the microphone assembly 202. In some embodiments, the dedicated output 208 includes a speaker configured to emit a noise (e.g., beep, tone, simulated voice) to provide the indication of the state of the microphone assembly 202. In some embodiments, the dedicated output 208 may include a movement or vibration source (e.g., motor, vibrator, etc.). In some embodiments, the dedicated output 208 includes a thermal source (e.g., electric heating coil). Such an output may be provided through a sound port acoustically coupled to the transducer 204, such that no design modifications to the host device 200 are required in some cases to provide the improved microphone assembly 202 described herein in an existing design of a host device 200. For various host devices 200, providing the output through a sound port minimizes the number of holes needed in the host device 200, which can minimize the risk of water, dust and debris entering the host device 200. Accordingly, the location of the microphone assembly 202 at a physical edge of the host device 200 increases the benefit of placing security features into the microphone assembly. It should be understood that the current disclosure contemplates many implementations of the dedicated output 208.

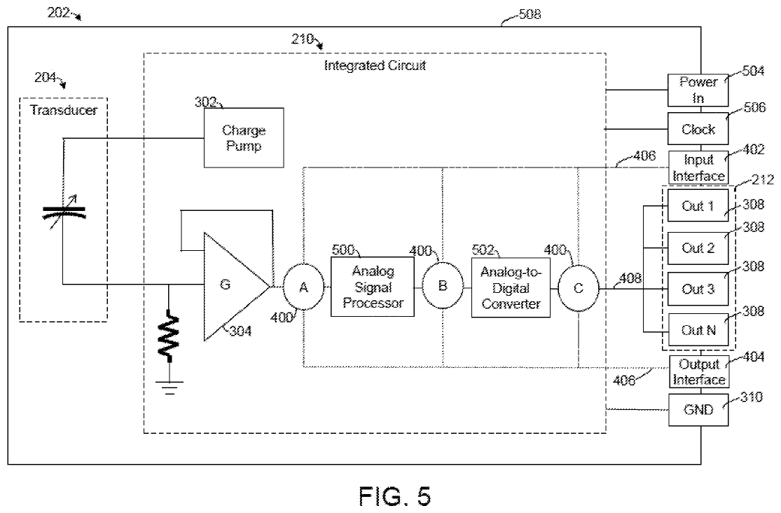

Referring now to FIG. 3, a schematic circuit diagram of the microphone 108 of FIG. 1 is shown. The microphone 108 is shown to include a transducer 204 and a circuit (ASIC) 300. The circuit 300 includes a charge pump 302, an amplifier 304, a host input interface 306, a host output interface 308, and a ground 310. The host output interface 308 may be configured with flexibly assigned uses to generate any number of types of digital signals, i.e. PDM, I2S, SPI, UART, Soundwire, I2C. The host output interface 308 and the host input interface 306 correspond to the host device interface 212 of FIG. 2.

The circuit 300 is configured to receive a power supply voltage V_{DD} at the host input interface 306 from the host circuitry 104 via a host communication path. The charge pump 302 uses the power supply voltage to provide a controlled voltage V_{CP} to the transducer 204. The voltage V_{CP} is a bias voltage provided across the electrodes (e.g., diaphragm and backplate) of the transducer 204 and generates a capacitance between the electrodes. The diaphragm of the transducer 204 moves in response to acoustic activity (e.g., sound, noise, voices, music) from a surrounding environment (e.g., created by a user proximate the host device 200), and the capacitance changes in response to movement of the diaphragm relative to the backplate. The amplifier 304 receives and amplifies the electrical signals and provides the amplified signal V_{OUT} at the host output interface 308. The amplified electrical signal is transmitted from the host output interface 308 to the host circuitry 104 via a host communication path. The microphone 108 thereby provides a signal (in the illustrated embodiment, an analog signal) indicative of the acoustic activity to the host circuitry 104.

Notably, any inputs (e.g., power, i.e., V_{DD}) or outputs (e.g., V_{OUT}) to or from the microphone 108 pass through the host circuitry 104. In other words, the microphone 108 does not include any features capable of providing output to a user or receiving input from a user without such information passing through the host circuitry 104. Because the host circuitry 104 may be hacked or otherwise compromised as discussed above, any inputs and outputs to or from the microphone 108 are subject to the threat of manipulation or hacking. A user may therefore lack any reliable or trustworthy way to enter a command to the microphone 108 or ascertain a current state of the microphone 108.

Referring now to FIG. 4, a circuit diagram of a first example embodiment of the microphone assembly 202 is shown, according to an exemplary embodiment. As shown in FIG. 4, the microphone assembly 202 includes the integrated circuit 210 and the transducer 204. Similar to the circuit 300 of FIG. 3, the integrated circuit 210 is shown to include the charge pump 302, amplifier 304, host input interface 306, host output interface 308, and ground 310, which are operable as described above to provide an amplified electrical signal V_{OUT} at to the host circuitry 104 via a host communication path and the host output 308.

The integrated circuit 210 is also shown to include a switch 400 communicable with an input interface (pin, contact, etc.) 402 and an output interface (pin, contact, etc.) 404 via a secure path 406. The secure path 406 is isolated from a host path 408. The switch 400 is controllable between a closed position and an open position to connect and disconnect the amplifier 304 from the host output interface 308. When the switch 400 is in the closed position, the amplifier 306 is conductively connected to the host output interface 308 and the transducer 204 is allowed to provide an electrical signal to the host circuitry 104. The microphone assembly 202 may be said to be in an unmuted state. When the switch 400 is in the open position (i.e., as shown in FIG. 4), the amplifier 304 is disconnected from the host output interface 308 and the transducer 204 is prevented from providing an electrical signal to the host circuitry 104. The microphone assembly 202 may be said to be in a muted state.

The switch 400 is controllable by the integrated circuit 210 from the closed position to the open position and vice versa in response to commands received at the input interface 402 via the secure path 406. That is, the input interface 402 may receive a command to change the state of the microphone assembly 202 (e.g., to mute the microphone assembly 202). The command may be transmitted by the secure path to the integrated circuit 210 (e.g., to the switch 400 of the integrated circuit 210). The integrated circuit 210 may change the state of the microphone assembly 202 by changing the position of the switch 400 in accordance with the command.

The integrated circuit 210 may also transmit an indication of the state of the microphone assembly 202 via the secure path 406 to the output interface 404. For example, the switch 400 may be configured to provide an electrical signal to the output interface 404 indicative of the position of the switch 400 (i.e., indicating whether the switch 400 is in the open position or the closed position). In some embodiments, a current is provided to the output interface 404 when the switch 400 is in the closed position and no current is provided to the output interface 404 when the switch 400 is in the open position. It should be understood that the format of the indication of the state of the microphone assembly 202 provided to the output interface 404 may vary across embodiments to ensure compatibility with the type of dedicated output 208 included with the microphone assembly 202.

The output interface 404 is situated on the secure path such that the output interface 404 is isolated from the host communication path and the host circuitry 104. Additionally, an element of the integrated circuit 210 that provides the indication of the state of the microphone assembly 202 to the secure path is also isolated from the host communication path and the host circuitry 104. Accordingly, the indication may not be created, modified, falsified, or otherwise altered by the host circuitry 104 or via the network 102. In other words, the integrated circuit 210 is structured such that the indication of the state of the microphone received at the output interface 404 is guaranteed to always accurately represent the current state of the microphone.

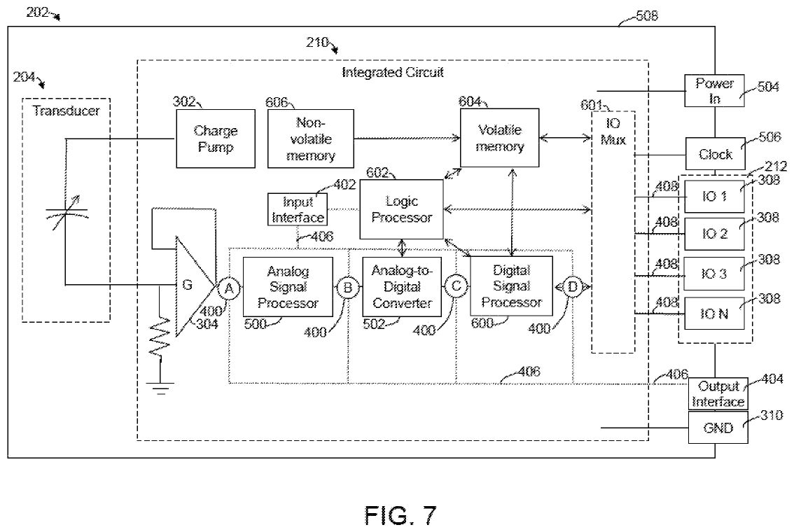

Referring now to FIG. 5, a second example embodiment of the microphone assembly 202 is shown. In the example of FIG. 5, the microphone assembly 202 is configured to provide digital output to the host circuitry 104 via a host communication path. As shown in FIG. 5, the microphone assembly 202 includes an analog processing circuit 500 and an analog-to-digital converter 502 in addition to the charge pump 302, transducer 204, and amplifier 304 as in FIGS. 3-4, all housed within a housing 508. A sound port through the housing allows acoustic activity to reach the transducer 204.

The integrated circuit 300 receives supply power from power-in pad 504 and clock time from clock pad 506. As described above, the charge pump 302 uses the supply power to provide a charge at the transducer 204, which provides an analog voltage signal to the amplifier 304 indicative of acoustic activity at the transducer 204. In the embodiment of FIG. 300, the amplifier 304 amplifies the electrical signal and provides the electrical signal to an analog signal processor 508. The analog signal processor 508 is configured to process the analog signal, for example to reduce noise in the analog signal or otherwise improve the quality of the analog signal, and provides the processed analog signal to the analog-to-digital converter 502. The analog-to-digital converter 502 is configured to convert the analog signal to a digital signal indicative of the acoustic activity at the transducer 204 and provide the digital signal to one or more host output interfaces 308 (shown as Out 1, Out 2, Out 3, . . . through Out N) of the host device interface 212 (i.e., each host output interface 308 may be a contact/pin/pad/etc. of the host device interface 212). For example, in some embodiments, the digital signal may be provided as a series of bits, where each of Out 1 through Out N, provide different parts of the signal. In various embodiments, the host output interfaces 308 are configured as serial data channels, digital frame channels, or may provide a positive signal and inverse negative signal to create a differential signal. Different communication protocols will require configuration of the host output interfaces 308 (i.e. of Out 1 through Out N). The digital signal may be provided to the host circuitry 104 via the one or more host output interfaces 308 along one or more host communication paths.

As shown in FIG. 5, the microphone assembly 202 is also shown to include the input interface 402 and the output interface 404 connected to one or more switches 400 via a secure path 406. FIG. 5 shows three switches 400 (shown as switch A, switch B, and switch C). In various embodiments, the integrated circuit 210 may include any combination of one or more of the switches 400. The switches 400 are positioned in various locations along the host communication path(s) between the transducer 204 and the outputs 308 (i.e., between the transducer 240 and the host circuitry 104). Although the switches 400 are located along the host communication path such that the switches 400 may be operated to selectively interrupt the host communication path, it should be understood that the operation of the switches 400 may not be altered by commands, programming, signals, etc. transmitted via a host communication path in the embodiment shown. In other embodiments, the operation of the switches 400 may be altered by commands, programming, signals etc. transmitted via host communication with a secure output indication is provided to the output interface 404.

Each of the switches 400 is controllable (e.g., in response to a command received at the input interface 402) between a closed position in which an electrical signal indicative of the acoustic activity can be transmitted across the switch 500 and an open position in which the electrical signal is prevented from being transmitted across the switch. As shown in FIG. 5, switch A 400 is positioned between the amplifier 304 and the analog signal processor 500 and can be opened to prevent or closed to allow transmission of the amplified analog signal from the amplifier 304 to the analog signal processor 504. Switch B 400 is positioned between the analog signal processor 500 and can be opened to prevent or closed to allow transmission of the processed analog signal from the analog signal processor 500 to the analog-to-digital converter 502. Switch C 400 is positioned between the analog-to-digital converter 502 and the one or more host output interfaces 308 and can be opened to prevent or closed or allow transmission of a digital signal from the analog-to-digital converter 502 to the host output interfaces 308. Inclusion of one switch 400 may be sufficient to provide the advantageous described herein. Accordingly, a single switch 400 may be included in preferred embodiments.

As described above with respect to FIG. 4, each switch 400 is also configured to cause an indication of a state of the microphone assembly 202 (e.g., a position of the switch 400) to be transmitted to the output interface 404 via the secure path 406. The secure path 406 is shown as a dotted line in FIG. 5. The indication of the state of the microphone assembly 202 received at the output interface 404 is thereby guaranteed to accurately represent the state of the microphone assembly.

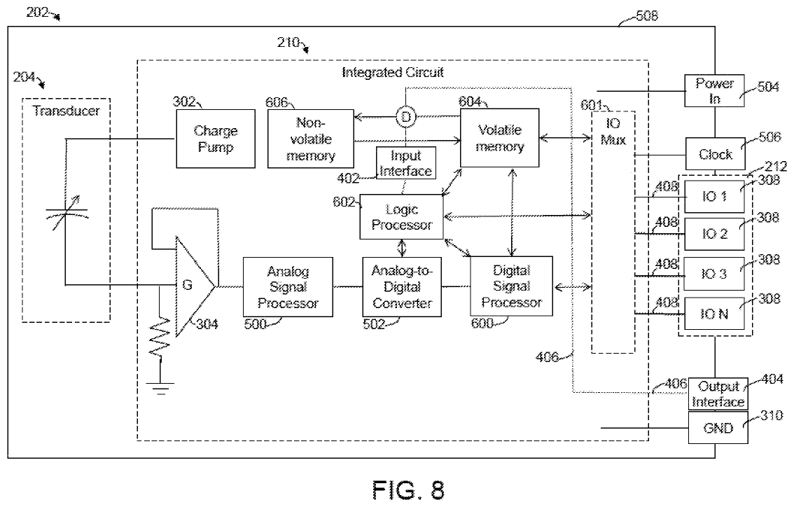

Referring now to FIG. 6, a third example embodiment of the microphone assembly 202 is shown. In the example of FIG. 6, the microphone assembly 202 is a “smart” microphone assembly. That is, the integrated circuit 210 of the microphone assembly 202 of FIG. 6 is configured to provide various data processing and computing functionalities independent of the host circuitry 104. For example, the microphone assembly 202 may be configured to provide audio processing, digital control options, specialized filtering, key word detection (e.g., wake word detection, etc.)

As used herein, “key word” refers to a particular input to the transducer 204. A key word may include an actual word spoken by the user of the host device 200, a sound created by the user, and/or a mechanical interaction with host device that produces an input to the transducer 204. In any case, the “key word” corresponds to an acoustic signature that can be recognized automatically within the electrical signals created by the transducer 204.

The integrated circuit 210 includes an input/output multiplexer 601, digital signal processor 600, a logic processor 602, a volatile memory 604 and a non-volatile memory 606, in addition to the analog signal processor 500 and the analog-to-digital converter 502 described above with reference to FIG. 5. Although shown on a single integrated circuit 210, it should be understood that the input/output multiplexer 601, digital signal processor 600, logic processor 602, volatile memory 604, non-volatile memory 606, analog signal processor 500, and analog-to-digital converter 502 may be included in multiple integrated circuits in alternative embodiments.

The input/output multiplexer 601 is configured to facilitate the transfer of signals between the integrated circuit 210 and multiple host input/output interfaces 308 (i.e., between the integrated circuit 210 and the host device interface 212) via host communication paths 408. In the example shown, the input/output multiplexer 601 facilitates the transmission of signals between the host input/output interfaces 308 and the digital signal processor 600, the logic processor 602, and/or the volatile memory 604.

The digital signal processor 600 is configured to receive a digital signal indicative of the acoustic activity at the transducer 204 and modify, filter, compress, or otherwise process the digital signal. The digital signal processor 600 may provide the processed signal indicative of the acoustic activity at the transducer 204 to the logic processor 602, the volatile memory 604, and/or the input/output multiplexer 601.

The logic processor 602 is configured to execute one or more programs in response to receiving the processed signal from the digital signal processor 600. Such rules-based programs may be stored by the volatile memory 604 and/or the non-volatile memory 606. As one example, the non-volatile memory 606 is configured to store a key word (e.g., wake word), i.e., data indicative of pattern of acoustic activity corresponding to a key word that may be spoken by a user of the host device 200. The key word may be associated with a particular output, command, change of state, or other alteration of the operation of the integrated circuit 310. The logic processor 602 may be configured to compare the processed signal from the digital signal processor 600 to the key word and determine whether the key word was spoken by the user. In response to a determination that the key word was spoken by the user, the logic processor 602 may generate an indication that a command was received and/or otherwise alter the operation of the integrated circuit in accordance with the key word. The logic processor 602 may be configured to execute various programs to provide various smart microphone functionality in various embodiments.

In the examples discussed herein, the non-volatile memory 606 is configured to store a key word (e.g., wake word) that may be spoken by a user to input a command to change a state of the microphone assembly 202. In some embodiments, the non-volatile memory 606 is non-reprogrammable. In some embodiments, for example as shown in FIG. 8 and described with reference thereto, the non-volatile memory 606 is reprogrammable. In such embodiments, the key word may be changed or replaced based on user preferences.

As in the example of FIG. 5, the microphone assembly 202 of FIG. 6 is shown to include multiple switches 400 arranged along a host communication path and connected to an input interface 402 and an output interface 404 along a secure path 406. As shown in FIG. 6, the integrated circuit 210 includes switches A-C 400 positioned and configured as described in reference to FIG. 5. The integrated circuit 210 of FIG. 6 also includes a fourth switch D positioned between the digital signal processor 400 and the input/output multiplexer 601. Switch D 400 is positioned between the digital signal processor 500 and the input/output multiplexer 601 and can be opened to prevent or closed or allow transmission of electrical signals between the digital signal processor 500 and the input/output multiplexer 601. Switch D 400 is configured to open or close in accordance with a command received at the input interface 402 and provide an indication of the position of the valve at the output interface 404. In various embodiments, any combination of one or more of the switches A-D may be included.

Referring now to FIG. 7, a fourth example embodiment of the microphone assembly 202 is shown. FIG. 7 also show a smart microphone assembly 202, where the integrated circuit 210 includes the input/output multiplexer 601, the digital signal processor 600, the logic processor 602, the volatile memory 604 and the non-volatile memory 606 described with reference to FIG. 6, as well as the charge pump 302 and the amplifier 304 described above with reference to FIG. 3. The microphone assembly 202 of FIG. 7 is also shown to include the switches A-D 400 positioned as in FIG. 6 and connected to an output interface 308 as in FIG. 6.

In the embodiment of FIG. 7, the input interface 402 is configured to receive the command to change the state of the microphone assembly 202 from the logic processor 602. Accordingly, in this alternative embodiment, the input interface may be an element internal to the integrated circuit 210 and defines a beginning of a secure path. For example, a user may speak a word or phrase proximate the microphone assembly 202 and corresponding acoustic activity may be transformed to an electric signal by the transducer 204. The logic processor 602 may receive a digital signal from the analog-to-digital converter 502 and/or the digital signal processor 600, and compare the digital signal to pre-stored digital signatures corresponding to one or more predefined keywords (e.g., stored by the non-volatile memory 606). The logic processor 602 may thereby determine whether a word spoken (or other noise generated) proximate the microphone assembly 202 matches a predefined keyword. In response to a determination that the word spoken proximate the microphone assembly 202 matches a predefined keyword, the logic processor 602 may generate a command corresponding to the predefined keyword and provide the command to the input interface 402. The command may then be transmitted to one or more switches 400 to cause the one or more switches 400 to change a state of the microphone assembly 202 in accordance with the command and/or provide an indication of the current state of the microphone assembly 202 to the output interface 404

In preferred embodiments, switch D 400 may be included and switches A-C may be omitted, such that electrical signals from the transducer 204 may be provided to the logic processor 602 via the digital signal processor 600 regardless of the position of the switch(es) 400. Voice commands may then be used to change the state of the microphone assembly 202 regardless of the current state of the microphone assembly 202.

Referring now to FIG. 8, a fifth example embodiment of the microphone assembly 502, according to an exemplary embodiment. As in FIG. 7, the integrated circuit 210 of FIG. 7 includes the integrated circuit 210 includes the input/output multiplexer 601, the digital signal processor 600, the logic processor 602, the volatile memory 604, the non-volatile memory 606, the charge pump 302, and the amplifier 304.

In the embodiment of FIG. 8, the non-volatile memory 606 may be modified, for example to replace a key word (wake word) stored therein. A signal may be transmitted from the volatile memory 604 to the non-volatile memory 606 to cause a new key word to be stored at the non-volatile memory 606. As shown in FIG. 8, a switch D 400 is positioned along the conductive path between the volatile memory 605 and the non-volatile memory 606. The switch D 400 may be controlled to a closed position to allow the signal to reach the non-volatile memory 606 (i.e., to allow the non-volatile memory 606 to be reprogrammed), in which case the microphone assembly 202 may be said to be in a reprogrammable state. The switch D 400 may also be controlled to an open position to prevent a signal from reaching the not-volatile memory (i.e., to prevent reprogramming of the non-volatile memory 606), in which case the microphone assembly 202 may be said to be in a non-reprogrammable state. In some embodiments, the switch D 400 is coupled to the secure path 406 such that reprogramming cannot take place without the user authorizing the reprogramming.

The switch D 400 may change position in response to a command from the input interface 402, which may receive the command from the logic processor 602. For example, the logic processor 602 may provide a command to enter a reprogrammable state in response to determining that a user spoke a command to enter the reprogrammable state in proximity to the transducer 204. The switch D 400 is also configured to provide an indication of the position of switch D 400 (i.e., an indication of the state of the microphone assembly 202) to the output interface 404 along the secure path 406. In such embodiments, reprogramming cannot occur without a user being made aware that a reprogrammable state was entered. The output interface 404 may thereby be provided with a reliable indication of whether the non-volatile memory 606 can currently be reprogrammed.

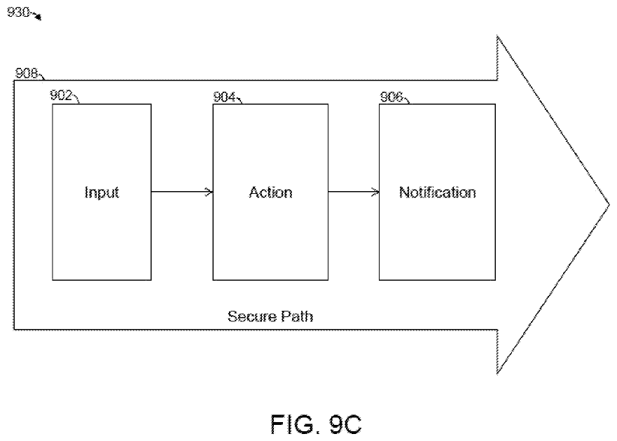

Referring now to FIG. 9A, an illustration depicting a framework 900 for ensuring a state of a microphone assembly is shown, according to an exemplary embodiment. The framework 900 includes an input step 902, an action step 904, and a notification step 906. In the illustration shown, the action step 904 and the notification step 906 are included in a secure path 908. The secure path 908 corresponds to the secure conductive path 406 discussed above.

The input step 902 corresponds to the receipt or creation of a command to change to the state of the microphone assembly 202 and/or to provide an indication of the current state of the microphone assembly 202. The input step 902 may include receiving a user command, for example a physical user input to a switch or button coupled to a host device 100. The input step 902 may also include determining that a spoken input from a user and sensed at the transducer 204 corresponds to a pre-stored key word. A command associated with the pre-stored key word is then generated as part of the input step 902.

The command enters the secure path 908 at the input step 902. After entering the secure path 908, the command and consequences of the command cannot be affected by an external influence. For example, the secure path 908 cannot be altered, reprogrammed, etc. by the host circuitry 104 or by a hacker communicable with the host circuitry 104 via the network 102.

The action step 904 corresponds to action taken to change a state of the microphone assembly 202. For example, a switch 400 may be opened or closed to change the state of the microphone assembly 202. As another example, the current state of the microphone may be ascertained at the action step 904. Various other actions relating to the state of the microphone assembly 202 are possible in various embodiments. The action step 904 can only be initiated via the secure path 908.

The notification step 906 corresponds to the presentation of information relating to the action step 904 to a user. At the notification step 906, the action (e.g., the change in state of the microphone assembly 202) causes an indication of the action to be generated. In the examples described above, the indication of the action may be transmitted to the output interface 308 and the dedicated output 208 where the indication is displayed or otherwise communicated to a user. FIG. 9 illustrates that the secure path 908 protects the notification step 906 from external interference or falsification, such that an indication provided to a user always accurately represents the action of action step 904.

Referring now to FIG. 9B, a second framework 920 for ensuring a state of a microphone is shown, according to an exemplary embodiment. In the second framework 920, the input step 902 and the action step 904 are included within the secure path 908, while the notification 906 is outside of the secure path 904. In such a case, receipt of a command and processing of the command (e.g., change of a state of the microphone) is done in a secure and isolated manner. Notification 906 may be accomplished outside of the secure path 908, for example via the host circuitry 104.

Referring now to FIG. 9C, a third framework 930 for ensuring a state of a microphone is shown, according to an exemplary embodiment. In the third framework 930, the secure path 908 includes the input step 902, the action step 904, and the notification step 906. In such a case, a command is received, an action is taken in accordance with the command, and a notification is provided to a user, all within the secure path 908 and isolated from outside influences such as the threat of hacking.

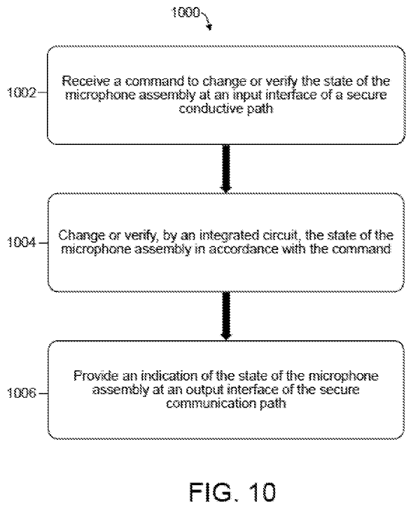

Referring now to FIG. 10, a flowchart of a process 1000 is shown, according to an exemplary embodiment. The process 1000 may be implemented with the various embodiments of the microphone assembly 202 shown in FIGS. 4-8, and reference is made thereto in the following description for the sake of example. It should be understood that other implementations of the process 1000 are possible.

At step 1002, a command to change or verify the state of the microphone assembly 202 is received at an input interface 402 of a secure path 406. The secure path 406 is isolated from a host communication path 408 that allows communication between the microphone assembly 202 and the host circuitry 104. Step 1002 corresponds to the input step 902 of FIG. 9.

At step 1004, the state of the microphone assembly 202 is changed or verified by the integrated circuit 210 in accordance with the command. For example, the command may request that the state of the microphone assembly 202 be changed to a muted state, and the integrated circuit 210 may act at step 1004 to change the state of the microphone assembly 202 to the muted state. Step 1004 corresponds to the action step 904 of FIG. 9.

At step 1006, an indication of the state of the microphone assembly 202 is provided at an output interface 404 of the secure communication path 406. The output interface 404 may provide the indication from the integrated circuit 210 to a dedicated output 208, for example to cause a light source of the dedicated output 208 to illuminate. Step 1006 corresponds to the notification step 906 of FIG. 9.

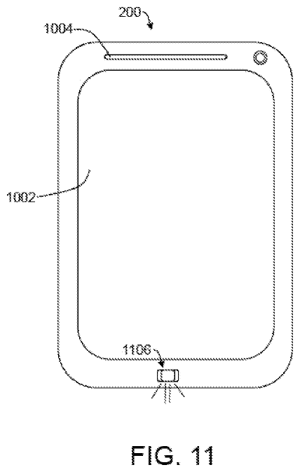

Referring now to FIG. 11, an example embodiment of the host device 200 of FIG. 2 is shown. As shown in FIG. 2, the host device 200 is a smartphone. The host device 200 may include output devices 106 that include a touchscreen display 1100 and a speaker 1102. The touchscreen display 1100 and the speaker 1102 are controlled by host circuitry 104 housed within the host device 200. Because the host circuitry 104 may be hacked or otherwise compromised, information presented via the touchscreen display 1100 or the speaker 1102 may be untrustworthy.

In the example of FIG. 11, the host device 200 includes a button 1106. The button 1106 is an example embodiment of an input 206 for the microphone assembly 202. The button 1106 may be manipulated by a user to input a command to the integrated circuit 210. For example, the button 1106 may be pushed or held by a user when the user desires that the microphone assembly 202 be placed in the unmuted state. Various other states may be associated with a push of the button 1106 in various embodiments.

The button 1106 of FIG. 11 includes an integrated light source that serves as a dedicated output 208. As shown in FIG. 11, the button 1106 is glowing (i.e., the integrated light source is illuminated). The button 1106 thereby indicates a state of the microphone. For example, the button 1106 may glow when the microphone assembly 202 is in the unmuted state, such that a user can clearly see when the microphone assembly 202 is collected data and providing the data to the host circuitry 104. In various embodiments, the button 1106 may illuminate in various colors, in various brightness, in various patterns (blinking patterns, flashing patterns, etc.), and with other user-perceptible variations to indicate different states.

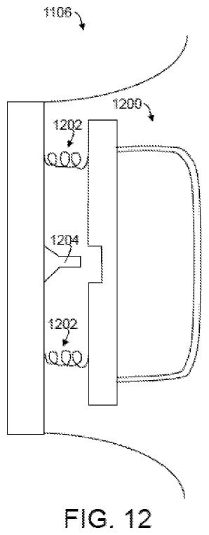

Referring now to FIG. 12, a detailed view of the button 1106 of FIG. 11 is shown, according to an exemplary embodiment. The button 1106 includes an engageable light source 1200 separated from the integrated circuit 210 by springs 1202. The engageable light source 1200 may include one or more light emitting diodes or other type of light source. The engageable light source 1200 may be engaged (e.g., pushed) by a user to depress the springs 1202 and bring the engageable light source 1200 in contact with a pin 1204. Contacting the pin 1204 may cause a command to be provided to the integrated circuit 210 to change a state of the microphone assembly 202. Contacting the pin 1204 to the light source 1200 may also cause the light source 1200 to illuminate. The button 1106 may thereby serve as both an input and output device of the microphone assembly 202. Accordingly, the button 1106 of FIG. 12 requires physical interaction of a user with the button 1106 in order for a change of state of the microphone assembly 202 and/or in order for an output indicative of the state of the microphone assembly 202 to be provided.

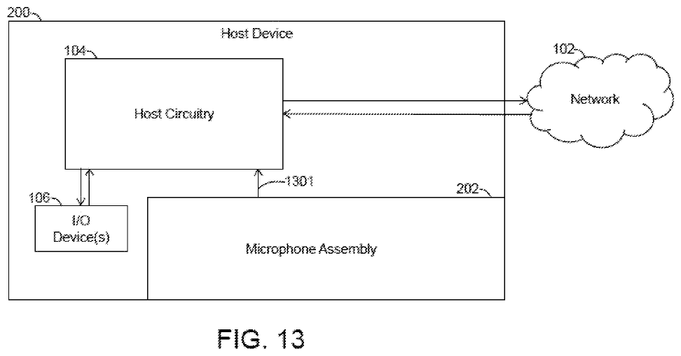

Referring now to FIG. 13, a block diagram of another implementation of the host device 200 is shown. In the example shown, the microphone assembly 202 provides data to the host circuitry 104 via a one-way data connection 1301. The one-way data connection 1301 does not allow the host circuitry 104 to provide data, commands, instructions, etc. to the microphone assembly 202. The microphone assembly 202 is thereby protected from being hacking. That is, the host circuitry 104 or any other device communicable with the host circuitry 104 via the network 102 is prevented from affecting the state of the microphone assembly 202.

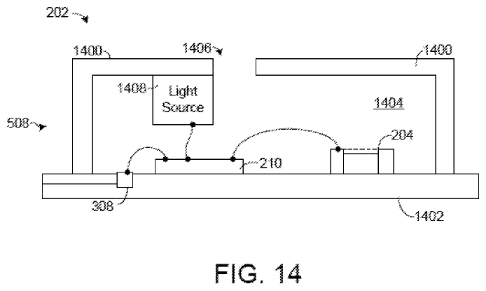

Referring now to FIG. 14, a cross-sectional view of a microphone assembly 202 is shown, according to an exemplary embodiment. In the example of FIG. 14, the microphone assembly 202 includes a lid 1400 coupled to a printed circuit board substrate 1402, which together form the housing 508 of the microphone assembly 202. An acoustic space 1404 is defined between the lid 1400 and the printed circuit board substrate 1402. A sound port 1406 extends through the lid 1400 and provides an opening between the acoustic space 1404 and an external environment. The MEMS transducer 204 and the integrated circuit 210 are located in the acoustic space 1404, i.e., between the lid 1400 and the printed circuit board substrate 1402. A light source 1408 is located in the acoustic space 1404 and communicably coupled the integrated circuit 210. The light source 1408 is configured to illuminate and project light out of the acoustic space 1404 through the sound port 1406, for example to indicate a state of the microphone assembly 202. The integrated circuit 210 is also shown as coupled to host device interface 308 positioned at the printed circuit board substrate 1402.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1-30. (canceled)

31. A microphone assembly comprising:
a housing having a host device interface;
a microelectromechanical systems (MEMS) transducer disposed in the housing and configured to generate electrical signals in response to acoustic activity;
an integrated circuit disposed in the housing and configured to process the electrical signals from the MEMS transducer and generate an output representative of the acoustic activity;
a host communication path between the integrated circuit and contacts of the host device interface;
a secure communication path between the integrated circuit and an output interface, the secure communication path isolated from the host communication path;
the integrated circuit configured to indicate a state of the microphone assembly at the output interface via the secure communication path in response to a command received at the microphone assembly.

32. The microphone assembly of claim 31, wherein the integrated circuit is configured to change the state of the microphone assembly to a new state in response to a command and to provide a new state indication signal at the output interface via the secure communication path.

33. The microphone assembly of claim 32, wherein changing the state of the microphone assembly comprises changing between mute and unmute states of the microphone assembly, between programmable and non-programmable states of the microphone assembly, or between microphone output encrypted or unencrypted states.

34. The microphone assembly of claim 32 further comprising an electromechanical device configured to provide the command to the integrated circuit via the secure communication path, wherein the state of the microphone assembly is controlled by the integrated circuit in response to the command.

35. The microphone assembly of claim 32, wherein the command is based on an output of the MEMS transducer provided to the integrated circuit via the secure communication path, wherein the state of the microphone assembly is controlled by the integrated circuit in response to the command.

36. The microphone assembly of claim 31, wherein the output interface is communicable with an output device, the output device comprising at least one of a light source, a sound source, a movement source, a vibration source, or a thermal source connected to the secure communication path.

37. The microphone assembly of claim 36, further comprising a sound port acoustically coupled to the MEMS transducer, wherein an indication from the output device is communicated via the sound port.

38. The microphone assembly of claim 36, wherein the integrated circuit is configured to change the state of the microphone assembly from a first state to a second state based on a command received via the secure communication path and the output device comprises a light source that indicates whether the microphone assembly is in the first state or the second state.

39. The microphone assembly of claim 31, wherein an input interface and the output interface constitute part of the secure communication path.

40. A microphone assembly comprising:
a housing having a host device interface;
a microelectromechanical systems (MEMS) transducer disposed in the housing and configured to generate electrical signals in response to acoustic activity;
an integrated circuit disposed in the housing and configured to process the electrical signals from the MEMS transducer and generate an output representative of the acoustic activity;
a host communication path between the integrated circuit and contacts of the host device interface;
a secure communication path between the integrated circuit and an input interface, the secure communication path isolated from the host communication path;
wherein the integrated circuit is configured to change a state of the microphone assembly via the secure communication path in response to a command received at the input interface.

41. The microphone assembly of claim 40, comprising an output interface communicable with the secure communication path and with an output device;
wherein the integrated circuit indicate the state of the microphone assembly at the output interface via the secure communication path.

42. The microphone assembly of claim 41 further comprising a sound port acoustically coupled to the MEMS transducer, wherein an indication from the output device is communicated via the sound port.

43. The microphone assembly of claim 41, wherein the integrated circuit is configured to change the state of the microphone assembly from a first state to a second state; and
wherein the output device comprises a light source that indicates whether the microphone assembly is in the first state or the second state.

44. The microphone assembly of claim 40, wherein changing the state of the microphone assembly comprises changing between mute and unmute states of the microphone assembly, between programmable and non-programmable states of the microphone assembly, or between microphone output encrypted or unencrypted states.

45. The microphone assembly of claim 40, further comprising an electromechanical device configured to provide the command to the integrated circuit via the secure communication path.

46. The microphone assembly of claim 40, wherein the command is based on an output of the MEMS transducer provided to the integrated circuit, wherein the state of the microphone assembly is controlled by the integrated circuit in response to the command.

47. The microphone assembly of claim 46, the integrated circuit comprising an amplifier or buffer having an input coupled to an output of the MEMS transducer, an analog-to-digital (A/D) converter having an input coupled to an output of the amplifier or buffer and a processor coupled to an output of the A/D converter, wherein the processor issues the command based on the output of the MEMS transducer.

48. The microphone assembly of claim 47, wherein the input interface and the output interface constitute part of the secure communication path.

49. A microphone assembly, comprising:
a microelectromechanical systems (MEMS) transducer configured to generate electrical signals in response to acoustic activity;
an integrated circuit configured to:
process the electrical signals from the MEMS transducer and provide an output of the acoustic activity to host circuitry via a host communication path;
detect a keyword in the electrical signals from the MEMS transducer;
determine that the keyword corresponds to a predetermined keyword; and
in response to determining that the keyword corresponds to a predetermined keyword, change or verify a state of the microphone assembly via a secure path and in accordance with a command associated with the predetermined keyword, the secure path isolated from the host communication path.

50. The microphone assembly of claim 49, wherein the integrated circuit is configured to provide an indication of the state of the microphone assembly to an output interface via the secure path.
